(19) United States
(12) Patent Application Publication
(10) Pub. No.: US 2026/0100972 A1
(43) Pub. Date: Apr. 9, 2026

(54) SYSTEMS, APPARATUS, AND METHODS FOR LINK-SPECIFIC DEVICE IDENTIFICATION

(71) Applicant: Kitu Systems, Inc., San Diego, CA (US)

(72) Inventors: Shawn Bruce, Pleasant Valley, NY (US); Katherine Killen Palumbo, San Diego, CA (US); Michael Hill, Temecula, CA (US); George Cagle, Madison, AL (US)

(73) Assignee: Kitu Systems, Inc., San Diego, CA (US)

(21) Appl. No.: 18/910,294

(22) Filed: Oct. 9, 2024

(51) Int. Cl. H04L 9/40; H04L 9/32

(52) U.S. Cl. CPC H04L 63/166; H04L 9/3263; H04L 63/0869

(57) ABSTRACT

Systems, apparatus, and methods for link-specific device identification. An identifier node may provide an identifier of a first node to at least one other node of a communication channel. The communication channel may be composed of multiple links and different links of the same communication channel may have different link-specific information. For example, mutual transport layer security (mTLS) assumes endpoint-to-endpoint encryption, and IEEE 2030.5 assumes client-server endpoints. However, a firewall may introduce a termination point for the control path information (packet routing addresses, etc.) but does not affect the data path (network socket information, etc.). The identifier node performs device identification based on the certificates associated with a link, before link termination. This link-specific identification may then be used by the IEEE 2030.5 server (instead of link-specific identification for the firewall).

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of secure communications technologies. More particularly, the present disclosure relates to systems, apparatus, and methods for managing device identification based on link-specific information.

### Description of Related Technology

Transport Layer Security (TLS) is a communication protocol that is used to secure communication channels over the internet. The Transport Layer Security (TLS) Protocol Version 1.2 was published August 2008, as RFC 5246, by the Internet Engineering Task Force (IETF) and is incorporated by reference in its entirety; The Transport Layer Security (TLS) Protocol Version 1.3 was published August 2018, as RFC 8446, by the IETF and is incorporated by reference in its entirety. Mutual TLS (mTLS) authentication adds an extra layer of security by requiring both the client and the server to authenticate each other using digital certificates.

The Institute of Electrical and Electronics Engineers (IEEE) promulgates the IEEE Standard for Smart Energy Profile Application Protocol (“IEEE 2030.5”); a first version was published in 2018 (“IEEE 2030.5-2018”) and a second version was published in 2023 (“IEEE 2030.5-2023), both of which are incorporated by reference in their entireties. This protocol prescribes certain methods and mechanisms for controlling smart energy devices such as, for example, distributed energy resources (DERs) and electric vehicle supply equipment (EVSE), via time-based controls and default controls. IEEE 2030.5 enables smart energy devices to more rapidly respond to energy parameters and may facilitate some forms of remote control.

IEEE 2030.5 specifies that mTLS is used for authentication to ensure that communication only occurs between authenticated parties. IEEE 2030.5 communication uses a certificate fingerprint to derive a long form device identifier (LFDI), and short form device identifier (SFDI) used for device identification.

### BRIEF DESCRIPTION OF THE DRAWINGS

FIG. 1 is a logical block diagram of a communication system useful to explain various aspects of the present disclosure.

FIG. 2 depicts a logical transaction diagram of various protocol layer transactions, useful to explain aspects of the present disclosure.

FIG. 3 depicts a logical transaction diagram of various protocol layer transactions, which incorporates an “intermediate termination” node (e.g., a firewall), useful to explain aspects of the present disclosure.

FIG. 4 is a logical transaction diagram of protocol layer transactions between network nodes, in accordance with various aspects of the present disclosure.

FIG. 5 is a logical transaction diagram of protocol layer transactions between network nodes, where identifier functionality is combined within a modified firewall, in accordance with various aspects of the present disclosure.

FIG. 6 is a logical block diagram of one system architecture, in accordance with various aspects of the present disclosure.

FIG. 7 is a logical block diagram of a client device, in accordance with various aspects of the present disclosure.

FIG. 8 is a logical block diagram of a server device, in accordance with various aspects of the present disclosure.

FIG. 9 is a logical block diagram of an identifier device, in accordance with various aspects of the present disclosure.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Mutual Transport Layer Security (mTLS) for IEEE 2030.5

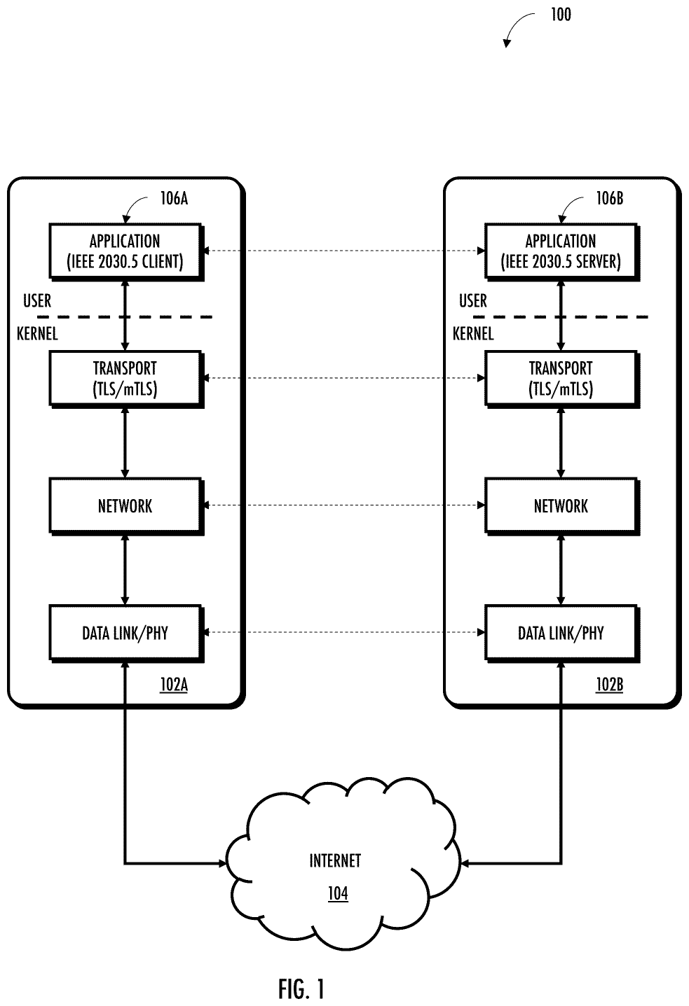

FIG. 1 is a logical block diagram of a communication system 100 useful to explain various aspects of the present disclosure. As shown a first node 102A is in communication with a second node 102B across an internet 104. The first node 102A and second node 102B each execute a communication stack (or “protocol stack”); each layer of the communication stack communicates with its logical counterpart in another device. For example, the network layer of the first node 102A communicates with the network layer of the second node 102B, the transport layer of the first node 102A communicates with the transport layer of the second node 102B, etc. Each layer additionally provides a level of abstraction to the layer above it; for example, the network layer handles networking functionality so that the transport layer does not need to, etc.

As a brief aside, the so-called “kernel” runs the core of the operating system, including low-level system processes, hardware drivers, and essential system management tasks. The kernel has direct access to the hardware and controls critical system functions. Kernel space applications are unrestricted. In contrast, the so-called “user space” (or “non-kernel space”) refers to applications that run outside of kernel space; applications in user space make system calls to interact with the kernel. Typically, user space applications run with restrictions. Restrictions control how an application may access data e.g., read, write, execute, etc. For example, a user application may have the ability to read, but not write to, a data structure.

Consider the following scenario where an mTLS (mutual Transport Layer Security) communication link is used to secure an IEEE 2030.5 transaction. As shown, an IEEE 2030.5 client application 106A running in user space may communicate with an IEEE 2030.5 server application 106B (also in user space). Both client application 106A and server application 106B transact data over an mTLS protocol layers running in kernel space.

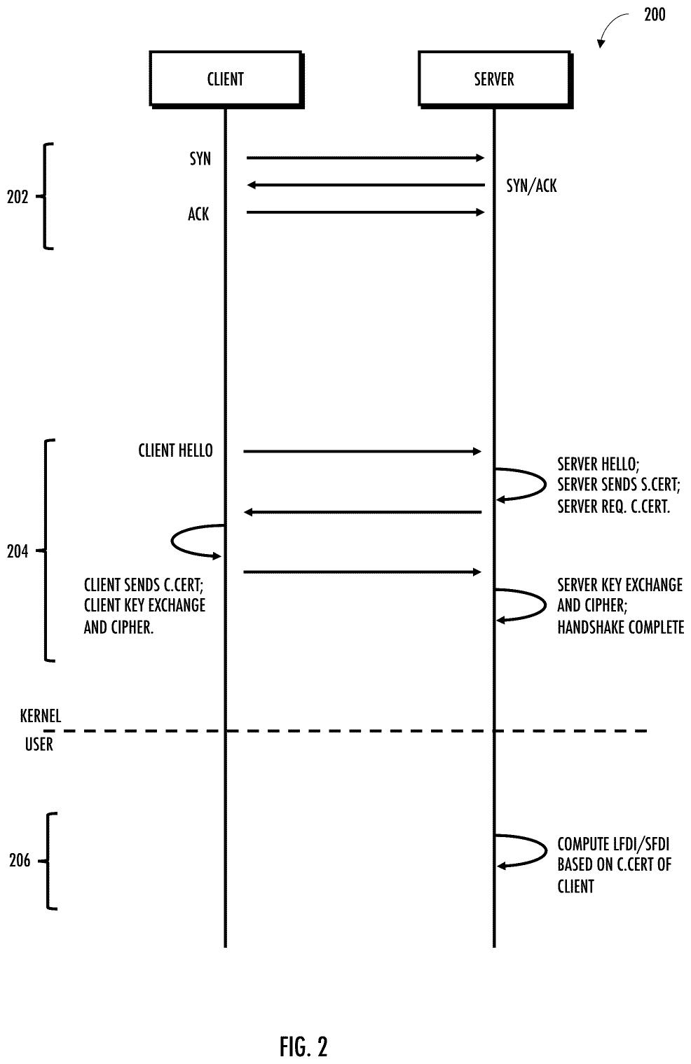

FIG. 2 depicts a logical transaction diagram 200 of various protocol layer transactions, useful to explain aspects of the present disclosure. As shown, a TCP connection is first initiated via a TCP handshake 202. First, the transport layer of the first node 102A sends a SYN packet to the transport layer of the second node 102B to request a connection. The SYN packet includes an initial sequence number (ISN) that is used to sequence packet delivery for the first node 102A. Upon receiving the SYN packet, the transport layer of the second node 102B sends a SYN-ACK packet that provides the ISN to sequence packet delivery for the second node 102B; the SYN-ACK packet also acknowledges the ISN of the first node 102A. The first node 102A responds to the SYN-ACK packet with an ACK packet to complete the TCP handshake 202 and establish a TCP connection. The TCP connection provides in-sequence delivery of TCP packets between the two nodes.

Once the kernel has established a TCP connection, the network connection is presented to the user space as a “socket”. The socket is a combination of an IP address and a port number, that uniquely identify a communication channel over the network. Each endpoint has its own socket (a pair of sockets) for the communication channel.

Here, the pair of sockets are additionally mutually authenticated and secured via mTLS (as specified for IEEE 2030.5 compliance). The mTLS protocol uses a TLS handshake 204 to establish a secure communication channel between a “client” and a “server”. In this example, the first node 102A is a client and the second node 102B is a server. First, the client sends a client hello message. The client hello message identifies supported TLS versions, supported ciphers, and a client random number to be used in key generation. The client hello message may include additional information such as session identifiers and other extensions.

The server responds to the client hello message with a server hello message. The server hello message selects the TLS version and cipher (selected from the client's hello message), and also provides a server random number for key generation. The server hello message may also include additional information such as session identifiers and other extensions. The server also sends its digital certificate to the client for authentication. Here, the certificate is issued by a trusted Certificate Authority (CA) which can be verified using the server's public key. In some cases, the server may also send additional key material, etc. The server also requests the client's certificate.

The client authenticates the server's certificate (verified and valid) and extracts the server's public key. The client may then generate key material (a “premaster secret”) for session keys. The key material is encrypted with the server's public key and sent to the server along with the client's certificate.

Both the client and the server independently generate session keys (symmetric keys) using the premaster secret, client random number, and server random number. These “ephemeral keys” can be used to encrypt and decrypt data for the session (ephemeral keys are temporary and discarded after use). Ephemeral keys provide forward secrecy—i.e., even if current keys are compromised, previous communications remain secure. The client and server then exchange finished messages that are encrypted with the session key; the finished messages may include message hashes to ensure that the handshake has not been tampered with.

Once the kernel has established a secure mTLS link, the pair of sockets can be used to transfer application payloads in user space. In this case, the IEEE 2030.5 client application 106A and the IEEE 2030.5 server application 106B can transact data packets via the opened sockets.

Device identification for the IEEE 2030.5 communication protocol (step 206) uses a certificate fingerprint to derive the long form device identifier (LFDI) and short form device identifier (SFDI). The LFDI is a unique, globally scoped identifier for a device (20 bytes). The IEEE 2030.5 communication protocol derives the LFDI from a SHA-256 hash of the device's MAC address and globally unique identifier (GUID). The SFDI is a reduced size identifier (64 bits) which may be used in situations where a shorter identifier is sufficient (e.g., legacy applications on smaller, local, and/or private networks, etc.). In either implementation, this information is directly extracted from the client certificate which was previously authenticated during the TLS handshake 204, discussed above.

Enterprise information technology (IT) infrastructure often requires extensive usage of firewalls, gateways, routers, and/or other intermediate nodes to implement e.g., security, re-direction, and/or scalability. As a brief aside, a data packet may include control path information (e.g., addressing, length, checksums) to route a payload to a destination. For example, a header for a TCP/IP packet may provide control path information that identifies a source port (of a source endpoint), a destination port (of a destination endpoint), a length of the packet, sequence numbers, and a packet cyclic redundancy check. Additional fields might include e.g., flags, window size, and/or other flow control path information. Control path operations are distinguished from data path operations; data path operations refer to the mechanisms that process and manipulate the packet payloads.

The term “endpoint” and its linguistic derivatives refers to any node that consumes, modifies, destroys, and/or generates the packet payloads (usually within user space or non-kernel space). In contrast, the term “intermediate” and its linguistic derivatives refers to any node that processes packets between endpoints (usually within kernel space). Firewalls, gateways, and routers are common examples of intermediate nodes. Intermediate nodes perform packet processing based on the control path information of the packet—e.g., routing, re-routing, filtering, duplicating, destroying, etc.

The term “link” and its linguistic derivatives refers to a logical connection between two nodes. The nodes may be endpoints and/or intermediate nodes (e.g., firewalls, gateways, routers, and other network appliances). In packet switched networks, packets are individually routed endpoint-to-endpoint (a communication channel) via a set of links. Packets may be dynamically switched along different links—packet routing may be selected to e.g., avoid network congestion, etc.

As used herein, the term “termination” and its linguistic derivatives refers to any node (endpoint or intermediate node) that consumes, generates, modifies, destroys, and/or replaces the link-specific information of a packet. For example, a received packet may be associated with a first link-specific encryption at a termination node and forwarded with a second link-specific encryption. Some (but not all) intermediate nodes are termination nodes. For example, a firewall may inspect a packet header to decide whether to allow, block, forward, and/or modify the control path information of a packet, whereas a router may inspect (but not modify) the packet header.

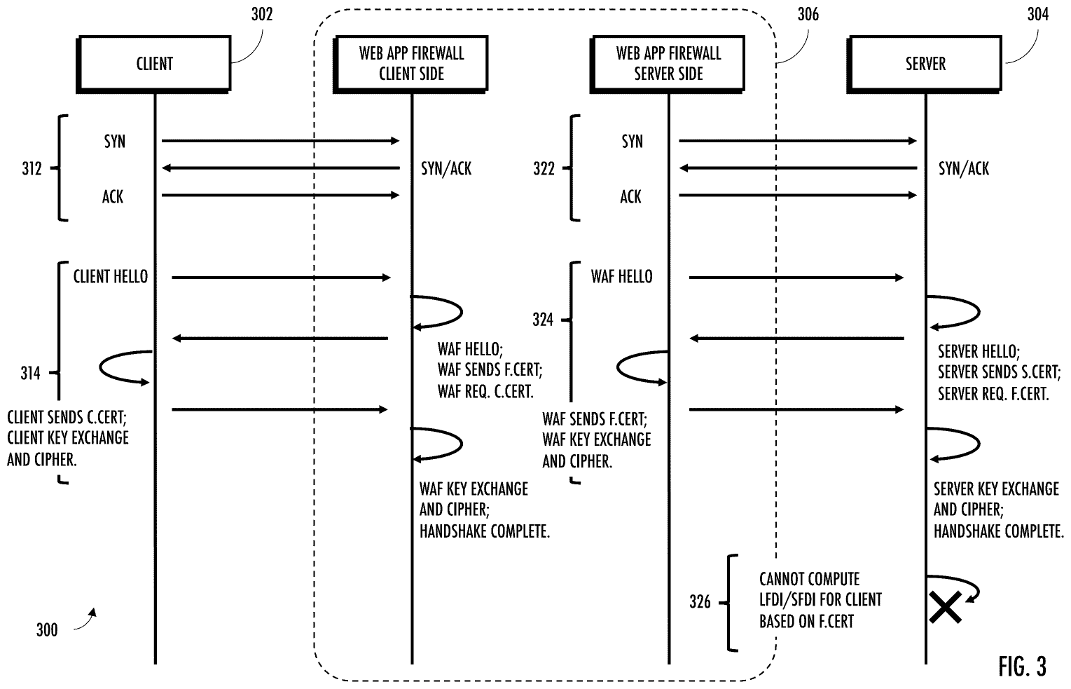

Referring now to FIG. 3, a logical transaction diagram 300 of various protocol layer transactions which incorporates an “intermediate termination” node (e.g., a firewall) is depicted. As shown, a first endpoint node (IEEE 2030.5 client 302) communicates with a second endpoint node (IEEE 2030.5 server 304) via an intermediary node (firewall 306). The firewall 306 isolates its internally trusted network from the external Internet (untrusted). Here, the first endpoint node (IEEE 2030.5 client 302) operates within the untrusted Internet and the second endpoint node (IEEE 2030.5 server 304) operates within the internally trusted network.

The first endpoint node (IEEE 2030.5 client 302) and the firewall 306 perform a first TCP handshake 312 to create a first pair of network sockets, and the firewall 306 and the second endpoint node (IEEE 2030.5 server 304) perform a second TCP handshake 322 to create a second pair of network sockets.

Each pair of network sockets establishes its own mTLS connection. Here, the first endpoint node (IEEE 2030.5 client 302) and the firewall 306 perform a first TLS handshake 314 to create a first mTLS connection and the firewall 306 and the second endpoint node (IEEE 2030.5 server 304) perform a second TLS handshake 324 to create a second mTLS connection. Importantly, the first mTLS connection and second mTLS connection are distinct; the first mTLS connection is terminated at the firewall before the second mTLS connection.

Unfortunately, any logical endpoint that terminates the mTLS connection between an IEEE 2030.5 client and IEEE 2030.5 server interferes with device identification for the IEEE 2030.5 communication protocol (step 326). More directly, the server only has access to the firewall's certificate from the second mTLS connection; the client device certificate is only used with the first mTLS connection.

### 2 Device Identification Before Link Termination

Various embodiments of the present disclosure perform link-specific device identification at an intermediary node before link termination. Here, the term “before” is used from the perspective of client traffic destined for the server (the intermediary node would be “after” link termination from the perspective of server traffic destined for the client). These concepts may be broadly extended to other applications that preserve, derive, and/or otherwise convey link-specific information (e.g., session identifiers and other extensions, etc.) regardless of network topology.

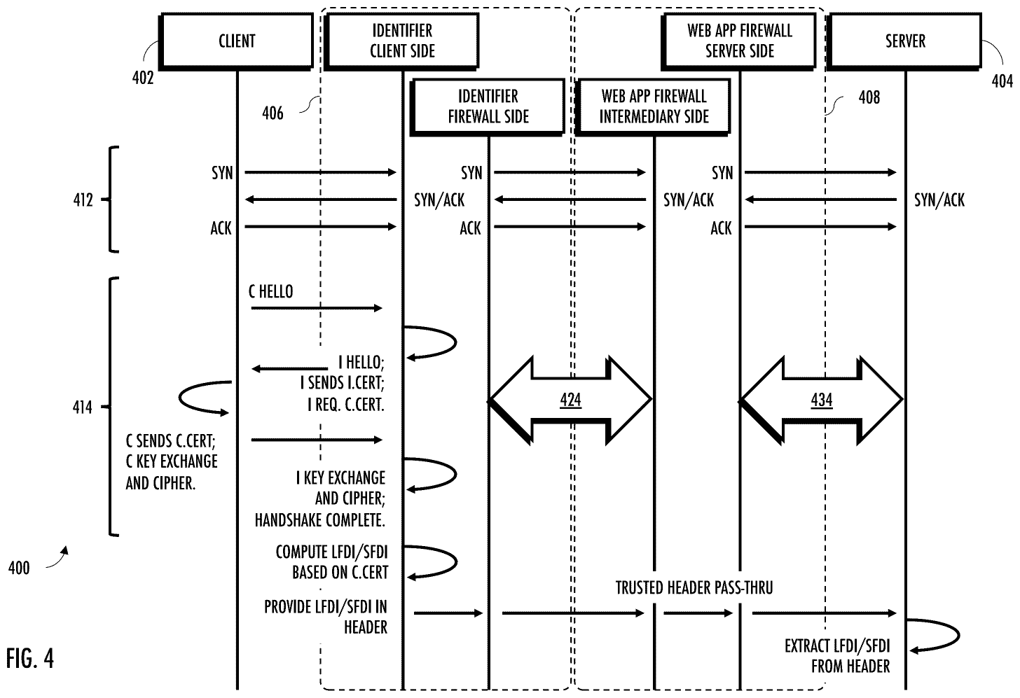

FIG. 4 is a logical transaction diagram 400 of protocol layer transactions between network nodes, in accordance with various aspects of the present disclosure. As shown, a first endpoint node (IEEE 2030.5 client 402) communicates with a second endpoint node (IEEE 2030.5 server 404) via intermediary nodes (identifier node 406 and firewall 408).

The identifier node 406 is configured to accept incoming IEEE 2030.5 device traffic and negotiate an mTLS connection. The identifier node 406 uses a unique device certificate generated during transport layer security negotiations to calculate IEEE 2030.5 identities (e.g., LFDI/SFDI). The IEEE 2030.5 identity is written to an HTTP header (or other messaging mechanism) for subsequent inspection by the firewall 408. Some variants may additionally extract and encode other link-specific information (e.g., IEEE 2030.5-compliant extensions, etc.).

The firewall 408 isolates its internally trusted network from the external Internet (untrusted). Here, the first endpoint node (IEEE 2030.5 client 402) and the identifier node 406 both operate within the untrusted Internet and the second endpoint node (IEEE 2030.5 server 404) operates within the internally trusted network. Importantly, the firewall 408 may parse HTTP headers to inspect IEEE 2030.5 device traffic—HTTP inspection of packet headers can be performed without decrypting data payloads. In other words, HTTP packet inspection in this manner does not violate IEEE 2030.5 requirements.

As shown, TCP handshakes 412 are performed for each of link of the communication path. A first pair of sockets is created for a first link between the first endpoint node (IEEE 2030.5 client 402) and the identifier node 406; a second pair of sockets is created for a second link between the identifier node 406 and the firewall 408; a third pair of sockets is created for a third link between the firewall 408 and the second endpoint node (IEEE 2030.5 server 404).

In this example, each pair of network sockets establishes its own transport layer security. Here, the first endpoint node (IEEE 2030.5 client 402) and the identifier node 406 create a first mTLS connection 414; the identifier node 406 and the firewall 408 create a second connection 424; and the identifier node 406 and the second endpoint node (IEEE 2030.5 server 404) create a third connection 434. Notably, however, since link-specific device identification occurs at the identifier node 406, any security protocol may be substituted for the second connection 424 and third connection 434 with equal success. In other words, mTLS connections may be used, but IEEE 2030.5-compliance does not require the second connection 424 and third connection 434 to be mTLS connections.

Once the first mTLS connection 414 has been established, the identifier node 406 calculates device identification for the IEEE 2030.5 client 402, using the client certificate obtained from the mTLS handshake. The LFDI and/or SFDI for the IEEE 2030.5 client 402 is provided to the IEEE 2030.5 server 404. In the illustrated example, the LFDI and/or SFDI are provided via a trusted HTTP header of an agreed-upon packet type that is passed (pending inspection) through the firewall 408. Other implementations may use out-of-band (OOB) messaging, etc.

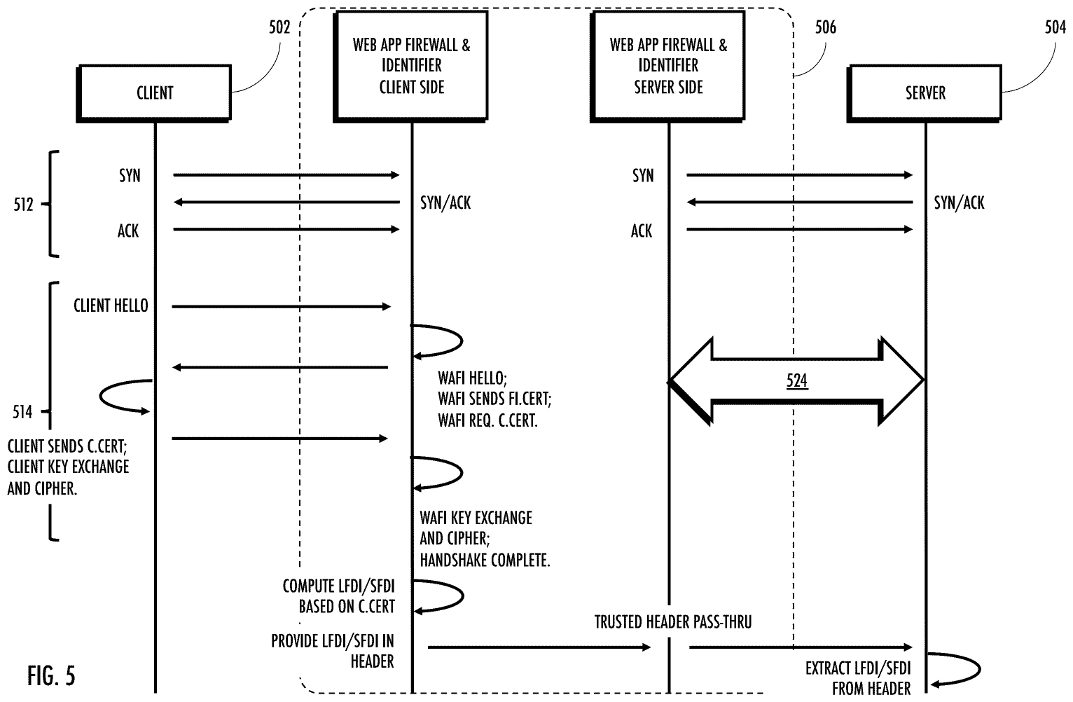

While the example of FIG. 4 is presented in the context of an identifier node 406, the principles described throughout may be logically subsumed within other nodes. For example, as shown in FIG. 5, the identifier functionality is combined within a modified firewall 506.

Much like the scheme discussed above, each of link of the communication path performs TCP handshakes 512. A first pair of sockets is created for a first link between the first endpoint node (IEEE 2030.5 client 502) and the modified firewall 506; a second pair of sockets is created for a second link between the modified firewall 506 and the second endpoint node (IEEE 2030.5 server 504). Then, the first endpoint node (IEEE 2030.5 client 502) and the modified firewall 506 create a first mTLS connection 514; the modified firewall 506 and the second endpoint node (IEEE 2030.5 server 504) create a second secure connection 524. Once the first mTLS connection 514 is established, the modified firewall 506 calculates device identification for the IEEE 2030.5 client 502, using the client certificate obtained from the mTLS handshake. The LFDI and/or SFDI for the IEEE 2030.5 client 502 is provided to the IEEE 2030.5 server 504.

More generally, artisans of ordinary skill given the contents of the present disclosure will readily appreciate that the techniques described throughout may be combined, further sub-divided, augmented, and/or subsumed within these or other subsystems. For example, link-specific device identification may be handled by the client itself, if the client is operating behind its own firewall, etc.

Conceptually, transport layer security/mutual transport layer security (TLS/mTLS) assume endpoint-to-endpoint encryption (in kernel space), and IEEE 2030.5 assumes client-server endpoints (in user space or non-kernel space). However, most large-scale network infrastructures make extensive use of network segmentation which introduces termination nodes in kernel space, but not in the user/non-kernel space. For example, a firewall introduces a termination point for the control path information (packet routing addresses, etc. in kernel space) but does not affect the data path (network socket information in user space or non-kernel space). The identifier functionality described above performs device identification based on the device certificates associated with a link, before link termination. This link-specific identification may then be used in user space after link termination, ignoring link-specific information that is no longer applicable to the user space.

While the foregoing examples are discussed within the context of mTLS and/or IEEE 2030.5, other communication protocols may be substituted with equal success. The techniques discussed herein may be applied to any user space (or non-kernel space) communication protocol that uses local network information and/or assumes a network topology, in communications with its peers. The techniques described herein are compatible with a variety of transport layer security (TLS) and/or mutual TLS (mTLS) protocols and can be seamlessly integrated into various network architectures and protocols.

As a related benefit, these techniques may be used to offload device identification from the IEEE 2030.5 server. This may allow for load balancing which may improve performance and/or resource utilization to increase system throughput. Furthermore, these techniques can be implemented with minimal adjustments (if any) to existing (legacy) IEEE 2030.5 client and/or IEEE 2030.5 server functionality.

As another benefit, ephemeral keys are generated for each mTLS connection session between clients and the identifier node. Localizing device identification to the identifier node does not otherwise affect client/server behavior, and certificates (or any other sensitive data) are not shared or distributed to other entities (e.g., firewalls, etc.). In other words, this scheme seamlessly integrates with, and preserves, existing security protocols.

### 3 System Architecture

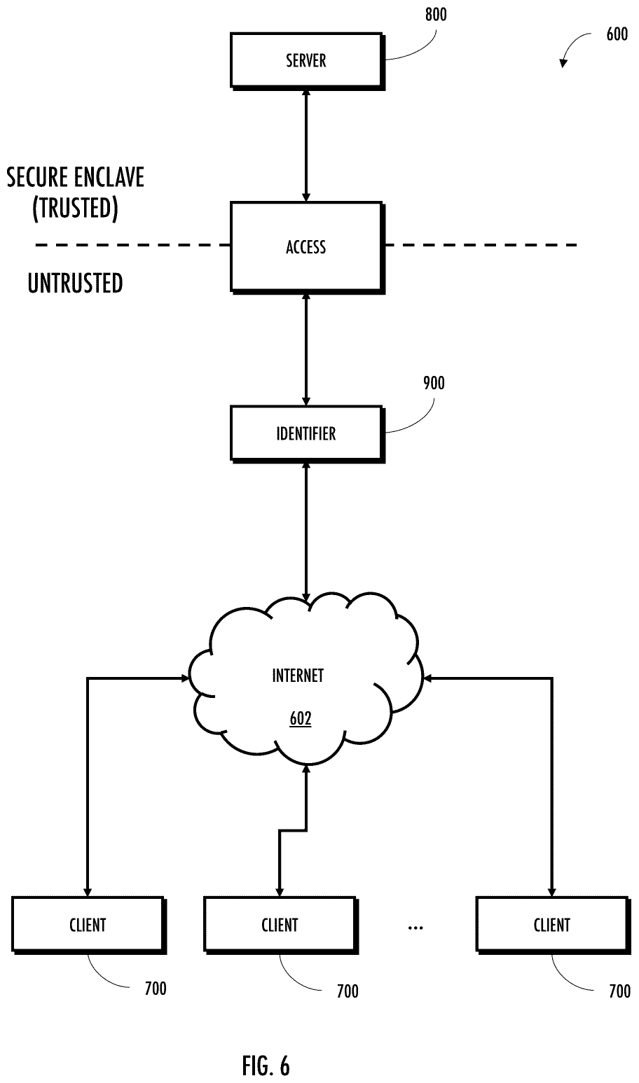

FIG. 6 is a logical block diagram of one system architecture 600. As shown, the network infrastructure includes: client node(s) 700, a server node 800, an identifier node 900, (and in some cases) an access control node. A “node” is any addressable entity of a network that can send, receive, store, and/or forward data packets. A logical node may be implemented as one or more physical devices—e.g., a single physical device might have multiple logical nodes, a single logical node may be implemented as multiple physical devices, etc.

The following examples are discussed in the context of a client/server system for energy management of power delivery (a so-called “smart grid”). In this system architecture, the client node(s) 700 operate within a public internet 602 (untrusted) and the server node 800 operates within a secure enclave (trusted); access to the secure enclave may be controlled by the access control node (if present). The identifier node 900 enables client identification, based on link-specific information, prior to accessing the secure enclave. More generally, however, artisans of ordinary skill in the related arts will readily appreciate that the functionalities described herein may be combined, divided, hybridized, and/or augmented within different entities. For example, a modified firewall may have both identifier node functionality as well as access node functionality.

While the present discussion is described in the context of a mutual transport layer security (mTLS) security protocol, other security protocols may be substituted with equal success. Similarly, while the following discussion is presented in the context of an IEEE 2030.5 communication protocol, other types of client/server communication protocols may be substituted with equal success. For example, IEEE 2030.5 includes a number of implementation guidelines, and is incorporated into other standards. The Common Smart Inverter Profile (CSIP) is one example of an IEEE 2030.5 implementation guideline for distributed energy resource (DER) integration; UL 1741 Supplement A is a guideline for grid-tied inverters, the SunSpec Alliance provides frameworks for a variety of other devices, etc. Other applicable standards may include e.g., IEEE 2030.7, IEEE 2030.8, IEEE 1547, IEC 61850, etc.

### 3.1 Client Node

Client nodes initiate communication, send requests, and process responses to manage an energy resource. Client node software (such as Spark™, developed by Kitu Systems, Inc.) may enable secure monitoring and intelligent control of distributed energy resources (DERs). For example, the client node software may enable advanced energy functions, context-based behavior adaptation, and coordination with local or remote energy management systems (EMS). In one specific implementation, the client node software may use a hardware agnostic operating system (such as Linux) and may include modifications for real-time operation, embedded, and/or low-powered applications.

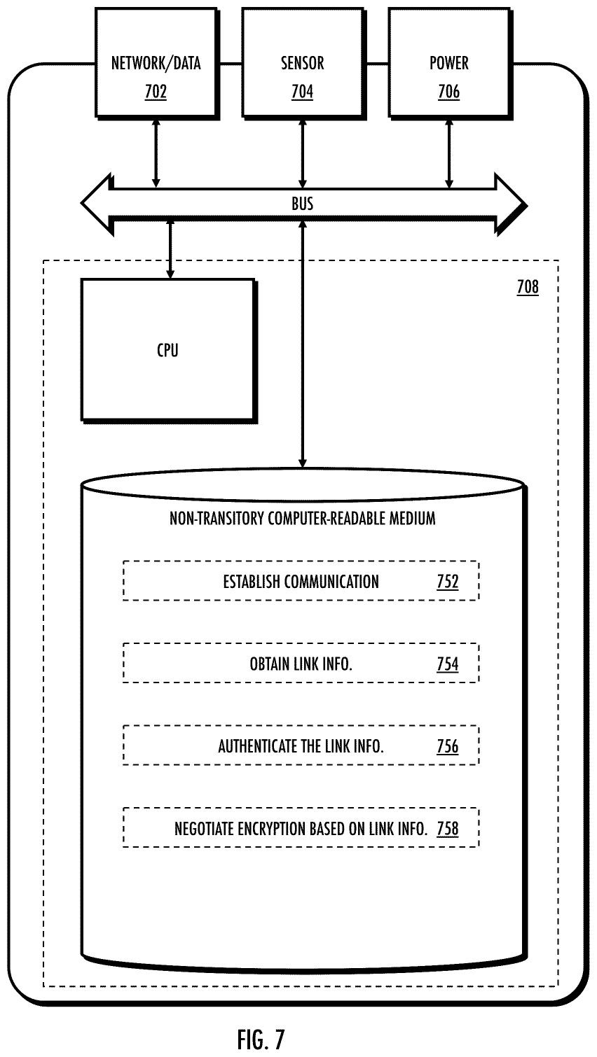

As shown in FIG. 7, a client device may include a data/network interface subsystem 702, a sensor subsystem 704, a power subsystem 706, and a control and data subsystem 708. During operation, the power subsystem generates, consumes, obtains, provides, stores and/or transfers power from one or more energy resource(s). The sensor subsystem monitors the power subsystem and/or the energy resource(s). The control and data processing logic obtains data generated by the client subsystems and/or measured from the energy resource(s), to perform calculations and/or data manipulations. The resulting data may be stored, rendered to a user, reported to a server node, or otherwise used by the client device to carry out its tasks. The data/network interface establishes a communication channel (via intermediary nodes) to the server node to report data and/or coordinate power subsystem operation.

The various logical subsystems described herein may be combined, divided, hybridized, and/or augmented within various physical components of a device. As but one such example, the control and data subsystems may be implemented as separate, or combined, physical assemblies. As another example, the power delivery subsystem may be centralized within a single component or distributed among many different components.

Functionally, the data/network interface subsystem enables communication between devices. For example, the client node may communicate with other networked devices (e.g., identifier nodes, access nodes, server nodes, etc.). The network interface may include both wired interfaces (e.g., Ethernet and USB) and/or wireless interfaces (e.g., cellular, local area network (LAN), personal area network (PAN)) to a communication network.

As used herein, a “communication network” refers to an arrangement of logical nodes that enables data communication between endpoints (an endpoint is also a logical node). Each node of the communication network may be addressable by other nodes; typically, a unit of data (a data packet) may be traverse across multiple nodes in “hops” or “links” (a segment between two nodes). For example, a client node may directly connect, or indirectly tether to another node with access to, the internet. “Tethering” also known as a “mobile hotspot” allows devices to share an internet connection with other devices. Thus, a smart phone may connect to the broader Internet (e.g., 5G/6G cellular); the smart phone may provide a mobile hotspot for a client device over a personal area network (PAN) interface (e.g., Bluetooth/Wi-Fi), etc.

The data/network interface subsystem may enable a client device to communicate with a server device according to a communication protocol. One embodiment of the client node may use the IEEE 2030.5 communication protocol. Examples of IEEE 2030.5 communications may include e.g., a response function set that is sent to a server by a client node to indicate the status of a time-based control event on the device. Such responses may indicate that the smart energy device has, for example, received, started, and/or completed a control event. In addition to such basic responses, the IEEE 2030.5 specification defines various user-based responses to demand response load control (DRLC) and/or distributed energy resource (DER) events.

Client network interactions may implement security mechanisms such as transport layer security (TLS), digital certificates, encryptions, and access control lists (whitelists, blacklists, etc.). Connections may provide endpoint-to-endpoint security. For example, a client node may connect to a server node (or other intermediary) via an untrusted public internet.

In some variants, the data/network interface subsystem may provide timestamped responses. Timestamped responses may enable the server to address e.g., loss of network conditions and/or other pre-defined trigger conditions. Various aspects of timestamped responses within the IEEE 2030.5 communication protocol are discussed in greater detail within U.S. patent application Ser. No. 17/317,743, filed May 11, 2021, now issued as U.S. Pat. No. 11,495,993, and entitled “System And Method For Facilitating Autonomous Operation Of A Smart Energy Device”, incorporated herein by reference in its entirety.

The data interface may also include one or more removeable media. Removeable media refers to a memory that may be attached/removed from the client device. In some cases, the data interface may map (“mount”) the removable media to the client device's internal memory resources to expand its operational memory.

Referring now to the sensor subsystem, a “sensor” refers to any electrical and/or mechanical structure that measures, and records, parameters of the physical environment as analog or digital data. In the context of power delivery, various sensors are used to monitor, measure, and manage the flow of electrical energy within power grids, substations, and at the consumer level. For example, sensors may be used to measure the amount of electricity that is generated, consumed, obtained, provided, stored, and/or transferred between the client device and an electrical grid.

The sensor subsystem may measure electrical current, voltage, power, temperature, frequency, and/or any other metric of power delivery. Measurements may be timestamped and/or location stamped. Furthermore, the sensor subsystem may perform data analysis to assess behavior and/or performance. Examples of such data analysis might include e.g., power quality, frequency drift, usage over time, etc.

Functionally, the power delivery subsystem refers to any electrical and/or mechanical structure that generates, consumes, obtains, provides, stores and/or transfers energy. In one specific implementation, the power delivery subsystem may be a distributed energy resource (DER). Unlike centralized energy generation, DERs are geographically located close to where energy is consumed. DERs may include various technologies such as solar panels, wind turbines, small natural gas-powered generators, energy storage systems like batteries, and demand response mechanisms. These resources are typically connected to the local distribution grid rather than the high-voltage transmission grid, and they can operate independently and/or in coordination with the centralized grid. DERs provide flexibility, resilience, and the ability to support renewable energy integration into the grid. Due to their modest scale, they may be (and often are) owned and operated by utility companies in conjunction with businesses and/or individual consumers.

Functionally, the control and data subsystem control the client node's operation and stores and processes transaction data. In one embodiment, the control and data subsystem use processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations. The control and data subsystem may include one or more of: a central processing unit (CPU), a digital signal processor (DSP), and a non-transitory computer-readable medium that stores program instructions and/or data.

In some implementations, the control and data subsystem may use a neural network processor. Unlike traditional “Turing”-based processor architectures, neural network processing emulates a network of connected nodes that loosely model the neuro-biological functionality found in the human brain. While neural network computing is still in its infancy, such technologies already have great promise for e.g., compute rich, low power, and/or continuous processing applications.

In one embodiment, the control and data subsystem includes a non-transitory computer-readable medium that stores instructions which, when executed by a processor, cause the client device to: establish communication with an identifier node, obtain link-specific information, and authenticate the link-specific information. In some variants, the link-specific information may additionally be used to e.g., negotiate encryption, etc.

In one embodiment, a client node establishes a communication link with an identifier node (step 752). In one specific implementation, the client node establishes a network connection to the identifier node via the data transport layer communication. For example, the network connection may be established via a TCP handshake which is a connection-oriented protocol that enables in-sequence packet delivery to/from the client node.

While the foregoing examples are discussed in the context of a connection-oriented transport layer communication, connection-less transport layer communication may be substituted with equal success. For example, the so-called user datagram protocol (UDP) provides connection-less communications. UDP sends data packets without sequencing, minimal error-checking, and/or acknowledgements. UDP is often used in applications where lost packets do not need to be re-transmitted (e.g., real-time applications and/or loss tolerant applications).

More generally, transport layer protocols establish, maintain, and/or terminate packet-based communications between network nodes. The transport layer enables the client to access the public internet, a private intranet, and/or any hybrid thereof. Once established, the client node may obtain a network address such that other entities of the network may directly, or indirectly, transact data with the client node.

Referring back to step 752, the identifier node may be known to the client in advance. For example, an identifier node may use a static address and/or port. In other embodiments, the identifier node may be discoverable—for example, the client may search a network directory service or other address look-up logic associated with an IP address. Still other implementations may combine the identifier node with other node functionality; for example, the identifier node may be incorporated within a firewall, gateway, router, or other network appliance which is otherwise known and/or discoverable to the client.

In one embodiment, the client node obtains link-specific information (step 754). Here, the link-specific information is associated with the client-identifier link (rather than endpoint-to-endpoint information). In one specific implementation, the link-specific information incorporates information from the client node and/or the identifier node. For example, the client node may request a digital certificate of the identifier node; similarly, the identifier node may request a digital certificate of the client node. Both client node and identifier node may have access to their own digital certificates, thus each node has both certificates that are specific to their link.

A digital certificate is a data structure used to prove establish the credentials of the certificate holder. Digital certificates are typically issued by a trusted entity known as a Certificate Authority (CA). A digital certificate often includes a public key of the certificate holder, certificate holder identification, issuer identification (for the CA), a digital signature, a validity period and a unique identifier. Some certificate data structures may be a chain of signed certificates.

In one embodiment, the link-specific information is authenticated (step 756). In mutual authentication variants, the client and the identifier node authenticate each other—in one-sided authentication variants, the client may authenticate the identifier node (or the identifier node may authenticate the client).

As used herein, the term “authenticate” and its linguistic derivatives refers to the processes and mechanisms for verifying and/or validating the identity of an entity. Here, validity/invalidity refers to the integrity of the certificate (whether the certificate has been corrupted, tampered with, etc.). Verification refers to the information that the certificate purports to convey. Verification and validity are closely inter-related; for example, a valid certificate may be unverifiable if e.g., the certificate authority of the trusted root certificate is unknown, similarly a verifiable certificate may be invalid due to expiration, etc.

The client device may verify the certificate chain by tracing the certificate chain up to a trusted root certificate. To validate each link of the certificate chain, the client device uses the public key of the CA (from the associated link in the chain) to decrypt the signature and compare it with the certificate's contents. If the signature matches, it confirms that the link in the certificate chain is valid and has not been tampered with or corrupted. In addition to validating the digital signatures, the client device may also check validity period, revocation status, etc. The certificate is verified if every link from the trusted root certificate is valid.

In one embodiment, the client node negotiates the communication link encryption with the identifier node, based on link-specific information (step 758). In other words, once successfully authenticated, the client node derives encryption information from the identifier node's digital certificate. As previously noted, rather than negotiating the communication link encryption between endpoints (e.g., the data path for user space applications), the client node negotiates encryption with the identifier node. In one specific implementation, the client node establishes transport layer encryption with an identifier node to secure the communication link. Within the context of transport layer security (TLS) and mutual transport layer security (mTLS), the client node and the identifier node negotiate applicable ciphers, versioning, etc. More generally, transport layer encryption may use any scheme for identification of nodes, supported ciphers, and/or protocols.

In some variants, the client may also use the previously negotiated ciphering scheme to generate ephemeral keys based on the digital certificates of the link. Notably, the ephemeral keys are specific to the authenticated link between the client node and the identifier node (the ephemeral keys are link-specific). The ephemeral keys may be used to encrypt subsequent transactions with the identifier node. In one embodiment, the client node and the identifier node may independently generate ephemeral keys.

While the foregoing discussion is presented in the context of ephemeral keys, any encryption key scheme may be substituted with equal success. Encryption keys may be symmetric or asymmetric, fixed or ephemeral. Other embodiments may transfer, negotiate, generate, or otherwise obtain encryption keys to secure transport layer communications. In one embodiment, the ciphering scheme protects subsequent application layer payloads; in one specific variant, the application layer payloads are handled in user space.

More generally, a variety of different data structures and/or mechanisms may be used to authenticate identities and/or secure transactions in a manner analogous to digital certificates. Examples of such techniques might include public key infrastructure (PKI) certificates, JSON web tokens, X.509 certificates, blockchain certificates, etc.

As discussed in greater detail below, the identifier node may use the link-specific information (digital certificates) to identify and/or authenticate the client. In one specific implementation, the identifier node may calculate a long form device identifier (LFDI) and/or short form device identifier (SFDI) used for device identification within the IEEE 2030.5 protocol. While the foregoing discussions are presented in the context of LFDI and SFDI identifiers, virtually any client node identifier may be substituted with equal success. Artisans of ordinary skill in the related arts will readily appreciate that any protocol that relies on link-specific information, which assumes a specific network topology, may benefit from the concepts discussed throughout.

### 3.2 Server Node

Server nodes initiate communication, send requests, and process responses to coordinate power delivery across a set of clients. Server node software (such as Citadel™ and Convoy™, developed by Kitu Systems, Inc.) may be used to coordinate client nodes and their associated distributed energy resources (DERs). Citadel enables secure communication with up to millions of interconnected DERs either directly or through an aggregator (such as Convoy). Citadel models the grid, collects and aggregates telemetry, and securely issues controls to ensure grid stability. Convoy is a DER communications aggregator, which enables DER providers to easily onboard their installations and comply with regulations (e.g., California Rule 21 requirements, etc.). More generally, server node software may provide visualizations of client node operation throughout a network topology. Client node behavior may be adjusted based on time, location, usage, etc. DER controls and commands may be defined, scheduled, and/or dispatched to individual nodes and/or groups of nodes. In one specific implementation, the server node software may operate over an open source, cross platform runtime environment (e.g., NodeJs) and provide database support (e.g., SQL).

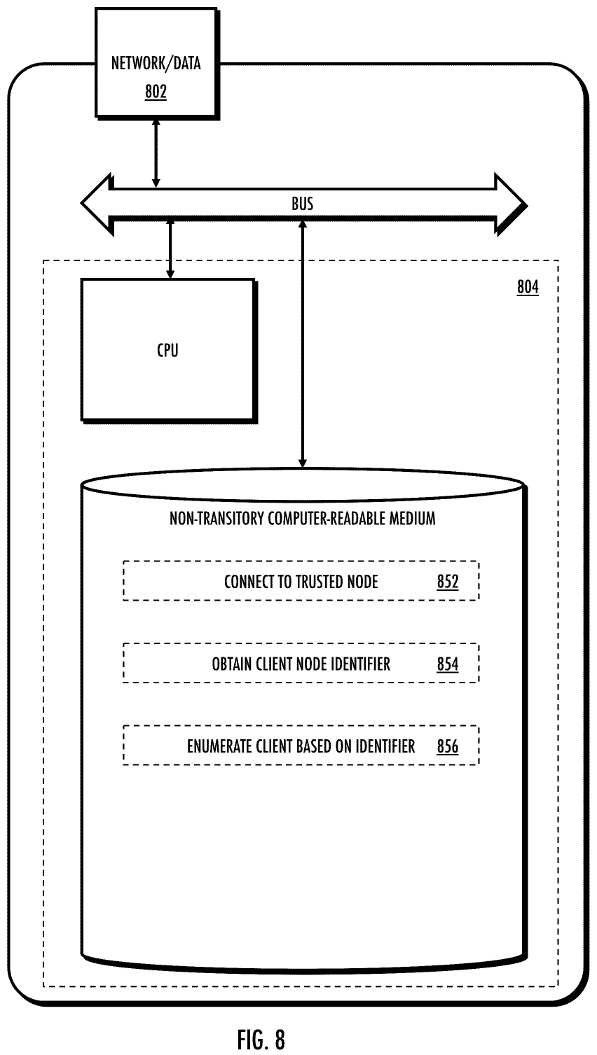

As shown in FIG. 8, a server device may include a data/network interface subsystem 802, and a control and data subsystem 804. During operation, the data/network interface establishes a communication channel (via intermediary nodes) to a population of client nodes to obtain reports and/or coordinate client operations. The control and data processing logic obtains reports generated by the client nodes to perform calculations and/or data manipulations; adjustments to client behavior are provided back to the client nodes to optimize their operation. The individual subsystems of the server node have many similarities in operation and implementation to the client node which are not further discussed below, the following discussion provides a discussion of the internal operations, design considerations, and/or alternatives, that are specific to server node operation.

The network interface may include both wired interfaces (e.g., Ethernet and USB) and/or wireless interfaces (e.g., cellular, local area network (LAN), personal area network (PAN)) to a communication network. The data/network interface subsystem may enable a server device to communicate with a client device according to a communication protocol. One embodiment of the server device may use the IEEE 2030.5 communication protocol.

Server network interactions may implement security mechanisms such as transport layer security (TLS), digital certificates, encryptions, and access control lists (whitelists, blacklists, etc.). Connections may provide endpoint-to-endpoint security. For example, a server device may connect to a client (or other intermediary) via an untrusted public internet.

Functionally, the control and data subsystem control the server device's operation and stores and processes transaction data. In one embodiment, the control and data subsystem use processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations. The control and data subsystem may include one or more of: a central processing unit (CPU), a digital signal processor (DSP), and a non-transitory computer-readable medium that stores program instructions and/or data.

In one embodiment, the control and data subsystem includes a non-transitory computer-readable medium that stores instructions which, when executed by a processor, cause the server device to: connect to a trusted node, obtain a client node identifier from the trusted node, and enumerate a client node based on the client node identifier.

In one embodiment, the server node establishes a network connection via the data transport layer communication. In one specific implementation, the network connection is established via a TCP handshake which is a connection-oriented protocol that enables in-sequence packet delivery to/from the server node. While the foregoing examples are discussed in the context of a connection-oriented transport layer communication, connection-less transport layer communication may be substituted with equal success.

In one embodiment, the server node operates within a trusted network. Communications within a trusted network may be optimized for traffic volume (e.g., reduced security measures, increased throughput, reduced latency, etc. relative to untrusted network operation). In other embodiments, the server node operates within an untrusted network. Untrusted networks may implement e.g., transport layer security (TLS) and mutual transport layer security (mTLS), etc. as discussed elsewhere.

In one embodiment, the server node connects to a trusted node (step 852). The trusted node may operate within a trusted network or an untrusted network. The trusted node is trusted to perform certain functions for the server node and/or is trusted to provide secure data for the server node. In some cases, the trusted node may be a firewall, gateway, router, or other network appliance. In some cases, the trusted node may be an identifier node. In one embodiment, the server node establishes a TCP connection for transacting data with the trusted node. The TCP connection may be presented to application space as a network socket; the data socket may be used to transact hypertext transfer protocol (HTTP) data.

In one embodiment, the server node obtains a client node identifier from the trusted node (step 854). In one embodiment, the client node identifier comprises a long form device identifier (LFDI) and/or short form device identifier (SFDI) used for device identification within the IEEE 2030.5 protocol. Conventionally, the LFDI and/or SFDI are derived from a digital certificate that is associated with the client node—here, the server node accepts the device identifier in plain text, via an HTTP packet provided in application space (via a network socket).

As a practical matter, some server implementations may support both device identifiers from trusted nodes as well as derived identifiers for client nodes that circumvent the trusted node and/or where the trusted node is unavailable (e.g., for legacy operation, etc.). For example, a server may accept LFDI/SFDI from a trusted node, as well as independent derivation via digital certificates. More generally, artisans of ordinary skill in the related arts will readily appreciate that the concepts described throughout may augment, rather than replace, existing mechanisms.

In one embodiment, the server node enumerates a client based on the client node identifier (step 856). Here, enumeration refers to the processes by which a server identifies and assigns resources to clients. Enumeration may include e.g., identification, resource assignment, initialization, integration, etc. For example, an IEEE 2030.5 server may identify the location of an IEEE 2030.5 client (and its associated DER) within the context of the broader smart grid. Once the IEEE 2030.5 client is enumerated, the IEEE 2030.5 server may monitor its operation, manage and/or coordinate its behavior relative to other IEEE 2030.5 clients.

In some variants, the control and data subsystem may bundle multiple control events together. Bundled control events may enable shared control of a client device between multiple entities. Various aspects of bundled control events are discussed in greater detail within U.S. patent application Ser. No. 17/572,322, filed Jan. 10, 2022, now issued as U.S. Pat. No. 11,994,834, and entitled “System And Method For Shared Control Of Distributed Energy Resources”, incorporated herein by reference in its entirety.

In some variants, the control and data subsystem may assess the reliability and/or availability of a client node. This may include monitoring an extent to which a client node is available to engage in communication over the network. Monitoring may also include determining whether the client node acknowledges control commands sent over the network and/or executes the control commands in conformance with at least one of a standard and a regulation. Various aspects of monitoring availability and/or reliability are discussed in greater detail within U.S. patent application Ser. No. 16/828,002, filed Mar. 24, 2020, now issued as U.S. Pat. No. 11,422,548, and entitled “System And Method For Assessing Availability And Reliability Of Distributed Energy Resources”, incorporated herein by reference in its entirety.

### 3.3 Identifier Node

The identifier node determines an identity of a client node for a server node. While the illustrated system of FIG. 6 depicts a logically distinct identifier node, some implementations may combine, further sub-divide, augment, and/or subsume identifier functionality within other nodes. For example, a modified access control node (e.g., a firewall, gateway, router, or other network appliance) may incorporate identifier node functionality; similarly, a client node or a server node may include some, or all, of the identifier node functionality.

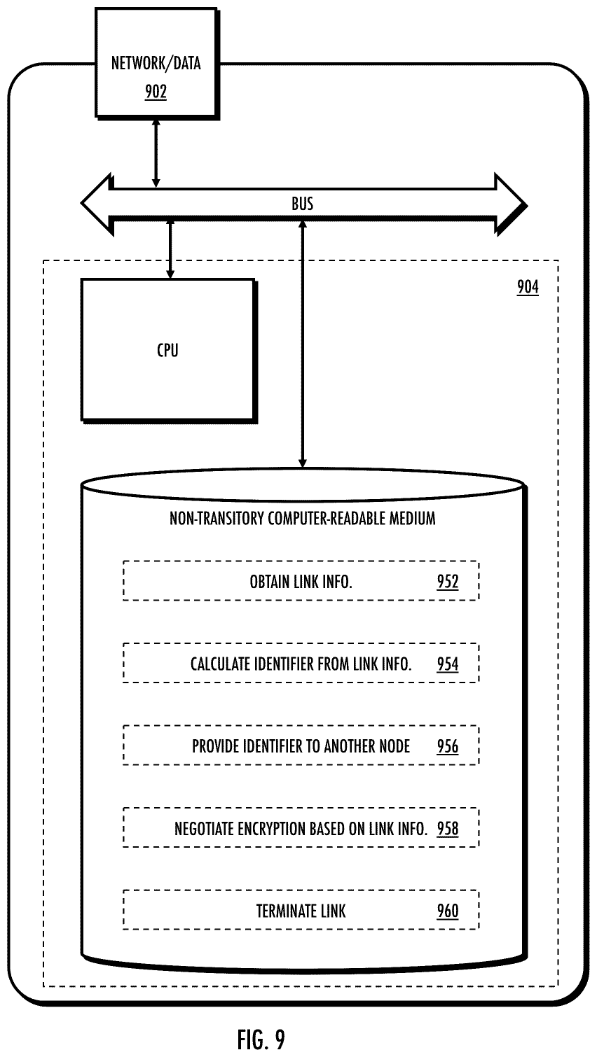

As shown in FIG. 9, an identifier device may include a data/network interface subsystem 902 and a control and data subsystem 904. During operation, the data/network interface establishes a transport layer communication channel to at least one client node; separately, the data/network interface connects to a server node. The control and data processing logic obtains a digital certificate that may be used to authenticate and identify a client node; the resulting client node identifier may be provided to the server node. The individual subsystems of the identifier node have many similarities in operation and implementation to the client/server subsystems which are not further discussed below, the following discussion provides a discussion of the internal operations, design considerations, and/or alternatives, that are specific to identifier node operation.

The network interface may include both wired interfaces (e.g., Ethernet and USB) and/or wireless interfaces (e.g., cellular, local area network (LAN), personal area network (PAN)) to a communication network. The data/network interface subsystem may enable an identifier device to communicate with a client and/or server according to one or more communication protocols.

Identifier node interactions may implement security mechanisms such as transport layer security (TLS), digital certificates, encryptions, and access control lists (whitelists, blacklists, etc.). In some implementations, the identifier node may operate within a trusted network secured by e.g., a firewall, etc. In other implementations, the identifier node may operate within an untrusted network (e.g., the public internet, etc.).

Functionally, the control and data subsystem control the identifier node's operation and stores and processes transaction data. In one embodiment, the control and data subsystem use processing units that execute instructions stored in a non-transitory computer-readable medium (memory). More generally however, other forms of control and/or data may be substituted with equal success, including e.g., neural network processors, dedicated logic (field programmable gate arrays (FPGAs), application specific integrated circuits (ASICs)), and/or other software, firmware, and/or hardware implementations. The control and data subsystem may include one or more of: a central processing unit (CPU), a digital signal processor (DSP), and a non-transitory computer-readable medium that stores program instructions and/or data.

In one embodiment, the control and data subsystem includes a non-transitory computer-readable medium that stores instructions which, when executed by a processor, cause the identifier device to: obtain link-specific information, calculate an identifier based on the link-specific information, and provide the identifier to another node. In some variants, the identifier node may additionally provide its own certificate and negotiate encryption based on the link-specific information. In some variants, the identifier device may additionally terminate, or otherwise modify, the link (while preserving the link-specific identifier).

In one embodiment, the identifier node obtains link-specific information (step 952). In one such embodiment, the identifier node is an intermediary node between two endpoints, and the link-specific information corresponds to a link between the identifier node and one of the other endpoints. More generally, however, identifier functionality need not be handled within the communication path. For example, out-of-band variants may place identifier node functionality outside of the endpoint-to-endpoint channel. While the concepts have been illustrated in the context of a client-server interaction, artisans of ordinary skill in the related arts will readily appreciate that concepts may be readily adapted to peer-to-peer interactions, etc.

Link-specific information refers to any characteristic, data structure, or metadata that is associated with a link of a communication channel composed of multiple links. Different links of the same communication channel may have different link-specific information. Examples of link-specific information may include e.g., node identifiers, link identifiers, session identifiers, sequence numbers, and/or any other such information.

In some variants, the identifier node may authenticate, verify, and/or validate the link-specific information. For example, an identifier node may authenticate a client node's certificate of a client-server interaction. In other variants, an identifier node may authenticate a server node's certificate of a client-server interaction, a peer node's certificate from a peer-to-peer interaction, etc. Other examples may verify the link-specific information based on shared secret, databases, observed behavior, and/or other monitored data. For example, an identifier node could verify another node's identity based on a cryptographic challenge (or other shared secret), etc. As another example, an identifier node could verify a node's identity based on their knowledge of session state, sequence number, etc.

In one embodiment, the identifier node may calculate an identifier for at least one node of the link, based on the link-specific information (step 954). In one specific variant, the identifier is associated with an endpoint of the link; e.g., a client node, a server node, and/or a peer node. In other variants, the identifier may be associated with an intermediate node of the link (e.g., a firewall, a gateway, a router, or other network appliance, etc.).

As previously mentioned, the IEEE 2030.5 communication protocol (step 206) uses a certificate fingerprint and SHA-256 hash along with device's MAC address and globally unique identifier (GUID) to derive the long form device identifier (LFDI) and/or the short form device identifier (SFDI) for device identification. Other identifiers may be substituted with equal success.

In one embodiment, the identifier node may provide the identifier of a first node to at least one other node of the communication channel (step 956). As previously mentioned, the communication channel may be composed of multiple links and different links of the same communication channel may have different link-specific information. In some variants, a first link of the communication channel with a first node may be routed via a first network, and a second link with a second node may be routed via a second network. Here, the identity of the first node may be provided to the second node (of a different network, having different link-specific information). Artisans of ordinary skill in the related arts will readily appreciate that the concepts described throughout may have broad applicability to hierarchical networks and/or sub-netted networks (e.g., where each subnet is a distinct segment of a larger network).

In some embodiments, different nodes of the communication channel may be in different networks of different restrictions. For example, a first node may operate within a public internet (or untrusted network) whereas a second node may operate within a private intranet (or trusted network). Large organizations often deploy multiple subnets for different departments, buildings, geographies, etc. Similarly certain types of service-oriented services (e.g., software as a service (SaaS), platform as a service (PaaS), etc.) may implement different subnets for different resources, services, etc.

In some variants, the identifier node may have a trusted relationship to one or more of the nodes. As a practical matter, the identifier node may be offload or otherwise obviate certain sensitive processing tasks (e.g., identification, key generation, etc.)—in some cases, it may not be feasible or possible to independently verify the identity provided by the identifier node. In some implementations, the identifier node may be externally accessible to a first node (via a publicly accessible network port), with a separate internally protected access to the second node. In other implementations, the identifier node functionality may be incorporated within other network security appliances (e.g., a firewall, gateway, etc.).

In one specific implementation, the identity may be provided via kernel space access (e.g., a direct write). In other implementations, the identity may be provided via user space (or non-kernel space) data structures. While the foregoing examples are described in the context of an HTTP packet addressed to an IEEE 2030.5 server node operating in user space, other data structures may be substituted with equal success.

In addition to identification, the identifier node may also affect other aspects of communication channel operation. In some embodiments, the identifier node may negotiate the communication link encryption with other nodes, based on link-specific information (step 958). In one embodiment, at least a first link (client-identifier) of a communication channel between two endpoints (client-server) is secured using the digital certificates of at least one of its nodes. In one variant, each link of the communication channel between two endpoints is secured using different link-specific information (e.g., client-identifier, identifier-server, etc.). As previously mentioned, an identifier node may negotiate applicable ciphers, versioning, etc. for transport layer security (TLS) and/or mutual transport layer security (mTLS).

In some embodiments, the identifier node may terminate a link (step 960). For example, a firewall with identifier functionality may introduce a termination point for the control path information (packet routing addresses, etc. in kernel space) without affecting the data path (network socket information in user space or non-kernel space). The identifier functionality described above performs device identification which may then be used in user space after termination, ignoring link-specific information that is no longer applicable to the user space.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method, comprising:
establishing a first link to a first node;
obtaining a first link-specific information for the first link;
calculating an identifier for the first node based on the first link-specific information; and
providing the identifier to a second node on a second link, where the second link is different than the first link.

2. The method of claim 1, where the first node is an IEEE 2030.5 client node and the second node is an IEEE 2030.5 server node.

3. The method of claim 2, further comprising securing the first link via a mutual transport layer security handshake.

4. The method of claim 3, where the first link-specific information comprises a digital certificate associated with the first node.

5. The method of claim 4, where the identifier for the first node comprises a long form device identifier or a short form device identifier.

6. The method of claim 5, where the identifier is provided to the IEEE 2030.5 server node via a hypertext transfer protocol packet.

7. The method of claim 6, where the second link comprises a terminating node and the second node.

8. An intermediate apparatus, comprising:
a network interface;
a processor; and
a non-transitory computer-readable medium comprising instructions that when executed by the processor, cause the intermediate apparatus to:
establish a first link to a first node;
obtain a first link-specific information for the first link;
calculate an identifier for the first node based on the first link-specific information; and
provide the identifier to a second node on a second link, where the second link is different than the first link.

9. The intermediate apparatus of claim 8, where the network interface is configured to communicate via a protocol stack comprising at least a transport layer and an application layer.

10. The intermediate apparatus of claim 9, where the transport layer is configured to secure the first link via a mutual transport layer security handshake with the first node and the application layer is configured to route IEEE 2030.5 packets between the first node and the second node.

11. The intermediate apparatus of claim 9, where the application layer is configured to provide hypertext transfer protocol packets to the second node.

12. The intermediate apparatus of claim 8, where the instructions further cause the intermediate apparatus to provide a second link-specific information for the first link to the first node.

13. The intermediate apparatus of claim 12, where the first link-specific information comprises a first digital certificate associated with the first node, and the second link-specific information for the first link comprises a second digital certificate associated with the intermediate apparatus.

14. The intermediate apparatus of claim 8, where the network interface is configured to terminate the first link or the second link.

15. A server, comprising:
a network interface;
a processor; and
a non-transitory computer-readable medium comprising instructions that when executed by the processor, cause the server to:
establish an endpoint-to-endpoint connection to a client node, the endpoint-to-endpoint connection comprising at least a first link and a second link;
obtain an identifier for the client node via the second link, where the identifier is based on link-specific information of the first link; and
enumerate the client node based on the identifier.

16. The server of claim 15, where the first link is routed via an untrusted network and the second link is routed via a trusted network.

17. The server of claim 16, where the first link is secured based on ephemeral keys negotiated during a mutual transport layer security handshake.

18. The server of claim 17, where the client node comprises an IEEE 2030.5 client and the identifier comprises a long form device identifier or a short form device identifier based on a client node certificate authenticated during the mutual transport layer security handshake.

19. The server of claim 17, where the second link is not encrypted.

20. The server of claim 19, where the identifier for the client node is obtained via a hypertext transfer protocol packet.
